(19) United States
(12) Patent Application Publication
(10) Pub. No.: US 2021/0076830 A1
(43) Pub. Date: Mar. 18, 2021

(54) STEP STOOL WITH TREAD

(71) Applicant: Elbee Pty Ltd., Bondi Junction (AU)

(72) Inventor: Andrew Marsden, Hingham, MA (US)

(21) Appl. No.: 16/571,057

(22) Filed: Sep. 13, 2019

(51) Int. Cl. A47C 12/00; E06C 1/39

(52) U.S. Cl. CPC A47C 12/00; E06C 1/39

(57) ABSTRACT

Treads are provided which allow a stepping surface to be made of a rubber, plastic, or other gripping material while limiting or eliminating recesses or corners that are difficult to clean. Concentric rings of alternating hills and valleys are provided on a top surface of a step. The hills and valleys are wide, have limited slopes, and reduce abrupt directional changes in the surfaces. A user can clean the surface easily with a sponge, towel, mop, or other cleaning tool because the cleaning surface can reach most or all of the tread surface.

### FIELD

Aspects of the present disclosure relate generally to step stools with treads, and more particularly to step stool with treads which provide grip and are easy to clean.

### DISCUSSION OF THE RELATED ART

Many step stools include a tread on the step surface(s) to reduce the risk of slipping. Some of the treads are formed of a rubber material.

### SUMMARY

According to one aspect, a step stool includes a first step having a first tread as a top surface, and one or more support members configured to be placed on a floor surface and to support and stabilize the first step above the floor surface. The first tread includes a first plurality of alternating elongated hills and valleys adjacent to one another along a top surface of the first tread. For each valley of the first plurality of elongated valleys, a slope of an imaginary line from a bottom of the valley to a peak an adjacent hill is less than 0.25 along a direction perpendicular to an elongation direction of the adjacent peak. For each valley of the first plurality of elongated valleys, a slope of an imaginary line from a bottom of the valley to a top of an adjacent peak does not exceed 0.5 along any portion of the imaginary line.

According to another aspect, a step stool includes a first step having a first tread as a top surface, and one or more support members configured to be placed on a floor surface and to support and stabilize the first step above the floor surface. The tread includes a first plurality of alternating elongated hills and valleys adjacent to one another, and a perpendicular cross-section of two or more of the plurality of alternating elongated hills and valleys has a top surface with a sinusoidal shape.

According to a further aspect, a step stool includes a first step having a first tread as a top surface, and one or more support members configured to be placed on a floor surface and to support and stabilize the first step above the floor surface. The first tread comprises a first plurality of alternating elongated hills and valleys adjacent to one another along a top surface of the first tread. Each of the hills of the first plurality of alternating elongated hills has a continuously curved shape in a direction perpendicular to a direction of elongation of the hill. A first peak of a first elongated hill of the first plurality of alternating elongated hills and valleys is positioned a first distance from a second peak of a second adjacent elongated hill of the first plurality of alternating elongated hills and valleys. A first bottom of a first elongated valley of the first plurality of alternating elongated hills and valleys is positioned a second distance from a second bottom of a second elongated valley of the first plurality of alternating elongated hills and valleys. The first elongated valley is positioned between the first and second elongated hills, and the second elongated valley is positioned adjacent to the second elongated hill. The first distance is no more than 10% different than the second distance.

According to another aspect, a method of manufacturing a step stool includes affixing a tread to a step of a step stool. The tread includes a first step having a first tread as a top surface, and one or more support members configured to be placed on a floor surface and to support and stabilize the first step above the floor surface. The first tread comprises a first plurality of alternating elongated hills and valleys adjacent to one another along a top surface of the first tread. For each valley of the first plurality of elongated valleys, a slope of an imaginary line from a bottom of the valley to a peak an adjacent hill is less than 0.25 along a direction perpendicular to an elongation direction of the adjacent peak. For each valley of the first plurality of elongated valleys, a slope of an imaginary line from a bottom of the valley to a top of an adjacent peak does not exceed 0.5 along any portion of the imaginary line.

### BRIEF DESCRIPTION OF DRAWINGS

Aspects of the invention are described below, by way of example, with reference to the accompanying drawings in which like numerals reference like elements, and wherein:

FIG. 1 is a top, front, left side perspective view of a step stool according to one embodiment of the present disclosure;

FIG. 2 is a perspective view of a tread according to one embodiment;

FIG. 3 shows a cross-section of a portion of a tread according to one embodiment; and

FIG. 4 is a perspective view of a tread according to an alternative embodiment.

### DETAILED DESCRIPTION

It should be understood that aspects of the invention are described herein with reference to certain illustrative embodiments and the figures. The illustrative embodiments described herein are not necessarily intended to show all aspects of the invention, but rather are used to describe a few illustrative embodiments. Thus, aspects of the invention are not intended to be construed narrowly in view of the illustrative embodiments. In addition, it should be understood that aspects of the invention may be used alone or in any suitable combination with other aspects of the invention.

Various embodiments are described in connection with a step stool having treads overmolded onto steps. However, the present disclosure is not necessarily so limited, and the treads may be employed on surfaces other than stepstools. For example, the treads disclosed herein may be used on floor mats. For ease of understanding, the treads are described in connection with a step stool having two steps, though step stools with only one step may be used, or step stools with three or more steps.

The present disclosure relates to step stool treads which provide desirable grip for a user while permitting easy cleaning of the treads. Step stools often have treads to increase friction between the step(s) of the stool and the bottom of the user's foot or footwear. For some conventional step stools, a gritty layer resembling sandpaper is attached to each step to provide friction. In other step stools, the tread is formed with closely spaced vertical fins made of stiff or flexible rubber or plastic. While both approaches can provide desirable friction characteristics, cleaning the treads can be difficult. In the case of rubber materials, the presence of gaps, corners, slots, etc. can be difficult to access with a sponge or towel or other typical cleaning implements.

According to the present disclosure, treads are provided which allow the surface to be made of a rubber, plastic, or other gripping material while limiting or eliminating recesses or corners that are difficult to clean. According to one arrangement, concentric rings of alternating hills and valleys are provided on a top surface of a step. The hills and valleys are wide, have limited slopes, and reduce abrupt directional changes in the surfaces. As such, a user can clean the surface easily with a sponge, towel, mop, or other cleaning tool because the cleaning surface can reach most or all of the tread surface. In step stools that have grip protrusions that form right angle walls with a tread surface base, the ninety degree corners can be difficult to clean.

By including protruding hills, the step stool treads disclosed herein can provide not only frictional resistance to lateral movement of user's foot, but also provide a physical blocking to lateral movement when an edge of a shoe is positioned within a valley.

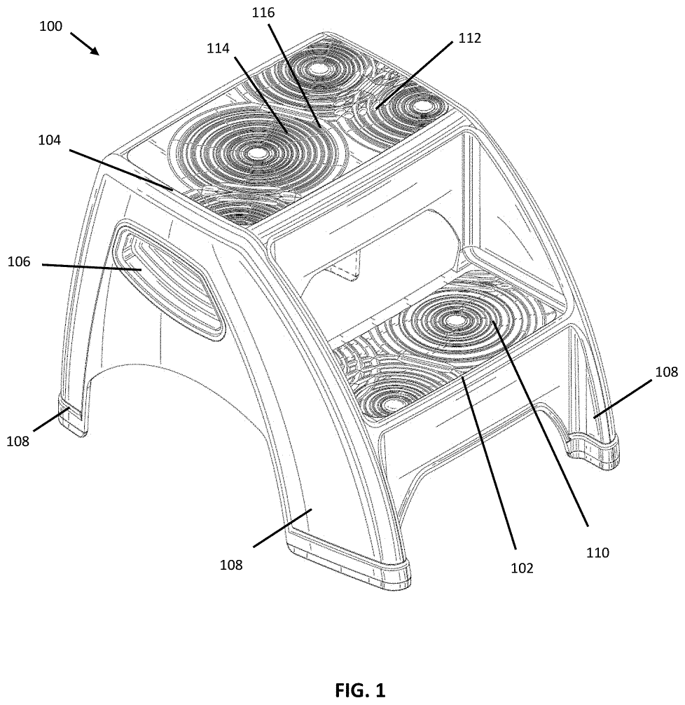

Turning to the figures, FIG. 1 show a step stool 100 with a first step 102 and a second step 104. A recessed handle 106 is shown on one side of the stool, and a similar handle may be provided on the other side of the stool. The stool includes four legs 108, though any suitable type of support member or members may be used to support and stabilize the stool. For example, in some embodiments, the step stool may be a round, rolling stool with a circular base, and include wheels. The wheels may recede into the stool when a user steps on the stool, at which point an outer rim of the stool base may primarily support the stool on the floor.

In the illustrated embodiment, the step stool is made of injection-molded plastic with overmolded treads. In other embodiments, the step stool may be made of any suitable material(s). For example, a folding step stool made substantially of steel or aluminum may incorporate aspects of the present disclosure.

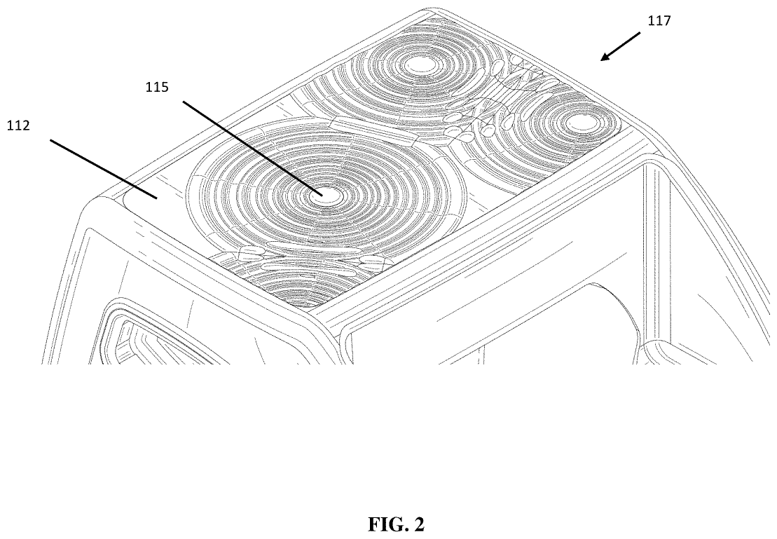

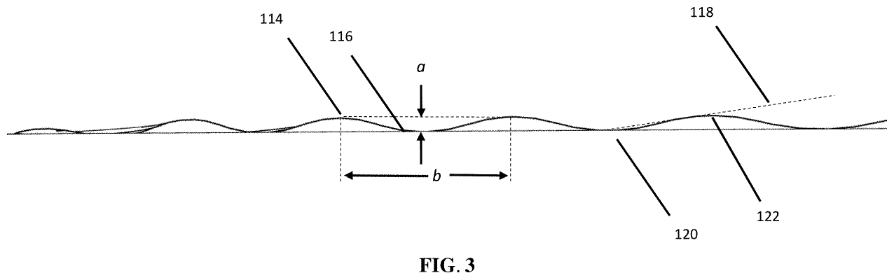

The first step 102 includes a first tread 110, and the second step 104 includes a second tread 112 according to the present disclosure. Second tread 112 has alternating hills 114 and valleys 116, which are shown in greater detail in FIGS. 2 and 3.

As visible in FIG. 2, the treads include features with a wave appearance in the illustrated embodiment, where a sinusoidal-shaped contour emanates from a center area 115. In some embodiments, multiple wave features are include on the same tread, such as shown in FIG. 2, where four partial or complete features are shown. The features may intersect with each other, and may imitate interfering waves 117 in their appearance some embodiments.

FIG. 3 shows a cross-sectional view of a portion of second tread 112 from FIG. 2. This view is illustrative of how a cross-section of one of the grip features forms a top grip surface with gently undulating hills 114 and valleys 116. In some embodiments, the shape is a sinusoidal curve.

By limiting or avoiding corners or abrupt direction changes in the surface, cleaning of the surface may be easier as compared to surfaces with tight spaces or corners. The valley walls have shallow slopes. For example, in some embodiments, the slope of an imaginary line 118 from a valley bottom 120 to a peak 122 may be 0.2 or less. In some embodiments, the slope is 0.15 or less. In some embodiments, the slope is between 0.1 and 0.2. In some embodiments, the slope is between 0.05 and 0.15. In some embodiments, the slope is less than 0.25. In some embodiments, Additionally, the slope of the valley wall at all points on the wall may be less than a certain value, such as less than 0.2, less than 0.25, or less than 0.5, as several examples.

The shape of the grip feature shown in FIG. 3 does not have any flat surfaces. Even as the surface passes over a peak 114, the rate of change in the slope of the surface (the second derivative) is less than zero. In other embodiments, the grip feature may include flat surfaces. For example, in some embodiments, the valley floor may include a flat surface and/or a top surface of the peak may include a flat surface.

Additionally, as shown in FIGS. 1 and 2, portions of the treads may have flat areas without protrusions and recesses. If the lowest point in a valley falls within a flat area, the bottom of the valley is considered to be the point that is closest to (or at) the mid-point between the two adjacent peaks. If the lowest point in a valley does not fall within a flat area, then the bottom is considered to be the lowest point.

The distances between adjacent peaks may be constant within a grip feature. Or, as would be described using wave terminology, the period may be constant. In other embodiments, such as the embodiment illustrated in FIG. 3, the distances between adjacent peaks may vary. For example, as the peaks become farther away from the middle of the pattern, the distances between the peaks may increase. In other embodiments, the peaks that are farther from the pattern middle may be closer to adjacent peaks as compared to the peaks which are closer to the middle.

The heights of the peaks may be consistent within a wave pattern and even among all the wave patterns on a tread. However, in some embodiments, the peak heights may vary within a wave pattern and/or as between wave patterns on the tread. For grip features that are not shaped to appear as wave patterns, the heights of the peaks may vary across the grip features, or the peaks may have consistent heights across the grip features.

By having valleys that are not too deep relative to the hills and/or flat surfaces of the tread, cleaning of the tread is facilitated. For example, in some embodiments, the ratio of a) the distance between two adjacent peaks to b) the average height of the two adjacent peaks relative to the valley low point between the peaks is at least eight. Such an arrangement allows access to the surface for cleaning with a typical cleaning implement. In some embodiments, all of the hills and valleys of a grip feature maintain at least a minimum ratio of a to b, such as a ratio of eight for example. In other embodiments a, majority of the hills and valleys of a pattern maintain at least a minimum ratio of a to b, such as a ratio of eight for example.

In other embodiments, the minimum ratio of a to b may be six, ten, twelve, or fourteen.

In some embodiments, each pattern is arranged such that a majority of the peaks of the pattern are spaced at least 10 mm from their adjacent peaks. In some embodiments, the pattern(s) are arranged such that all of the peaks are spaced at least 10 mm from their adjacent peaks. In other embodiments, adjacent peaks may be spaced by at least 12 mm from their adjacent peaks. In some embodiments, adjacent peaks are spaced by between 10 mm and 25 mm apart, and as mentioned above, a first pair of adjacent peaks on a tread or within a same feature on a tread may have the same spacing between them as other pairs of adjacent peaks, or a first pair of adjacent peaks may have a different spacing as compared to all or some of other pairs of adjacent peaks.

The distance between two adjacent peaks may be the same or with ±10% of the distance between two valley bottoms—one valley bottom being between the two adjacent peaks, and the other valley bottom being adjacent one of the two peaks.

According to some embodiments, the height of the valley peaks relative to the adjacent valley floors may be approximately 1.5 mm, between 1 mm and 2 mm, no more than 2 mm, between 1.5 mm and 3 mm, or between 1 mm and 1.5 mm.

In an alternative embodiment, the valley portions of a pattern may have a smooth contour with no corners, while the peaks may have a corner at the top. In this manner, the valleys can be reached for cleaning without inaccessible portions formed by concave corners, and the convex corners of the peaks also do not present a cleaning challenge.

The curvature of the hills and valley as seen from the top view (circular in FIGS. 1-2) may also aid with cleaning in some embodiments. In other embodiments, the shape of the hills and valleys are not circular, but may include straight lines, sharp corners, rounded corners, or other shapes.

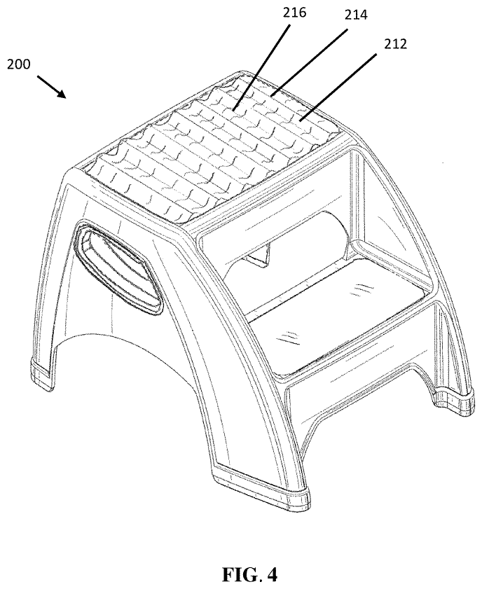

For example, as shown by way of example in FIG. 4, a step stool 200 may include sinusoidal wave shapes across a tread 212 with straight hills 214 and valleys 216 which are parallel to each other. The hills and valleys may extend front to back as shown, or side to side, or diagonally. The wave shapes are shown as larger relative to the step stool in FIG. 4 than in the embodiments with circular wave patterns, but in other embodiments, the size of the waves in the straight line pattern may be similar to the size of the waves in the circular patterns.

The middle of a wave pattern does not necessarily have to be a geometric middle of the waves surrounding the middle. The middle can represent the approximate region where the waves would have originated if formed by dropping an object into liquid.

The hills and valleys described herein do not require that the hills protrude higher than a base surface of the associated step, or that the valleys are recessed below a base surface of the associated step, though in some embodiments such an arrangement may be provided.

The tread or treads may be made of thermoplastic elastomer rubber in some embodiments. The tread may be overmolded onto the stool. Other suitable materials and methods of manufacture may be used. For example, the tread may be formed separately from the stool and then adhered to the stool.

For purposes of this patent application and any patent issuing thereon, the indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

The use of “including,” “comprising,” “having,” “containing,” “involving,” and/or variations thereof herein, is meant to encompass the items listed thereafter and equivalents thereof as well as additional items.

It should also be understood that, unless clearly indicated to the contrary, in any methods claimed herein that include more than one step or act, the order of the steps or acts of the method is not necessarily limited to the order in which the steps or acts of the method are recited.

The foregoing description of various embodiments are intended merely to be illustrative thereof and that other embodiments, modifications, and equivalents are within the scope of the invention recited in the claims appended hereto.

What is claimed is:

1. A step stool comprising:
a first step having a first tread as a top surface; and
one or more support members configured to be placed on a floor surface and to support and stabilize the first step above the floor surface;
wherein the first tread comprises a first plurality of alternating elongated hills and valleys adjacent to one another along a top surface of the first tread;
wherein, for each valley of the first plurality of elongated valleys, a slope of an imaginary line from a bottom of the valley to a peak an adjacent hill is less than 0.25 along a direction perpendicular to an elongation direction of the adjacent peak; and
wherein, for each valley of the first plurality of elongated valleys, a slope of a valley wall is less than 0.5 at all points on the valley wall.

2. A step stool as in claim 1, wherein a perpendicular cross-section of two or more of the first plurality of alternating elongated hills and valleys has a top surface with a sinusoidal shape.

3. A step stool as in claim 1, wherein, for each valley of the first plurality of elongated valleys, a slope of an imaginary line from a bottom of the valley to a peak of an adjacent hill is less than 0.20 along a direction perpendicular to an elongation direction of the adjacent peak.

4. A step stool as in claim 1, wherein each of the hills and valleys of the first plurality of elongated hills and valleys form a partial circle or a full circle.

5. A step stool as in claim 1, wherein each of the hills and valleys of the first plurality of elongated hills and valleys form rings.

6. A step stool as in claim 1, wherein each of the hills and valleys of the first plurality of elongated hills and valleys form concentric rings.

7. A step stool as in claim 1, wherein the first plurality of alternating elongated hills and valleys form all of the hills and valleys on the first tread.

8. A step stool as in claim 1, wherein an elongation direction of each of the hills and valleys of the first plurality of elongated hills and valleys is curved.

9. A step stool as in claim 8, wherein the first tread further comprises second plurality of alternating elongated hills and valleys adjacent to one another along a top surface of the first tread;
wherein, for each valley of the second plurality of elongated valleys, a slope of an imaginary line from a bottom of the valley to a peak of an adjacent hill is less than 0.25 along a direction perpendicular to an elongation direction of the adjacent hill;
wherein, for each valley of the second plurality of elongated valleys, a slope of a valley wall is less than 0.5 at all points on the valley wall;
an elongation direction of each of the hills and valleys of the second plurality of elongated hills and valleys is curved; and
the first plurality of hills and valleys intersects the second plurality of hills and valleys such that a first hill of the first plurality of hills and valleys interrupts a first valley of the second plurality of hills and valleys.

10. A step stool as in claim 9, wherein each of the hills and valleys of the first plurality of elongated hills and valleys form a partial circle or a full circle, and each of the hills and valleys of the second plurality of elongated hills and valleys form a partial circle or a full circle.

11. A step stool as in claim 1, further comprising a complete circle at a middle of the first plurality of hills and valleys, the circle having a peak at a center of the circle.

12. A step stool as in claim 11, wherein the peak at a center of the circle is taller than peaks of all the hills of the first plurality of hills and valleys.

13. A step stool as in claim 1, wherein an elongation direction of each of the hills and valleys of the first plurality of elongated hills and valleys is straight.

14. A step stool as in claim 1, wherein the tread is formed of a thermoplastic elastomer.

15. A step stool as in claim 1, further comprising a second step having a second tread as a top surface;
wherein the second tread comprises a second plurality of alternating elongated hills and valleys adjacent to one another along a top surface of the second tread;
wherein, for each valley of the second plurality of elongated valleys, a slope of an imaginary line from a bottom of the valley to a peak of an adjacent hill is less than 0.25 along a direction perpendicular to an elongation direction of the adjacent hill; and
wherein, for each valley of the second plurality of elongated valleys, a slope of a valley wall is less than 0.5 at all points on the valley wall.

16. A step stool comprising:
a first step having a first tread as a top surface; and
one or more support members configured to be placed on a floor surface and to support and stabilize the first step above the floor surface;
wherein the tread comprises a first plurality of alternating elongated hills and valleys adjacent to one another,
wherein a perpendicular cross-section of two or more of the plurality of alternating elongated hills and valleys has a top surface with a sinusoidal shape.

17. A step stool comprising:
a first step having a first tread as a top surface; and
one or more support members configured to be placed on a floor surface and to support and stabilize the first step above the floor surface; wherein
the first tread comprises a first plurality of alternating elongated hills and valleys adjacent to one another along a top surface of the first tread;
each of the hills of the first plurality of alternating elongated hills has a continuously curved shape in a direction perpendicular to a direction of elongation of the hill;
a first peak of a first elongated hill of the first plurality of alternating elongated hills and valleys is positioned a first distance from a second peak of a second adjacent elongated hill of the first plurality of alternating elongated hills and valleys;
a first bottom of a first elongated valley of the first plurality of alternating elongated hills and valleys is positioned a second distance from a second bottom of a second elongated valley of the first plurality of alternating elongated hills and valleys;
the first elongated valley is positioned between the first and second elongated hills;
the second elongated valley is positioned adjacent to the second elongated hill; and
the first distance is no more than 10% different than the second distance.

18. A step stool as in claim 17, wherein the first distance is equal to the second distance.

19. A step stool as in claim 17, wherein each of the hills of the first plurality of alternating elongated hills has a sinusoidal shape in the direction perpendicular to the direction of elongation of the hill.

20. A step stool as in claim 17, wherein each of the valleys of the first plurality of hills and valleys includes a flat portion.

21. A step stool as in claim 17, wherein each of the valleys of the first plurality of hills and valleys is continuously curved.

22. A step stool as in claim 21, wherein each of the valleys of the first plurality of alternating elongated hills has a sinusoidal shape in the direction perpendicular to the direction of elongation of the valley.

23-26. (canceled)
